(19) United States
(12) Patent Application Publication
(10) Pub. No.: US 2015/0339938 A1
(43) Pub. Date: Nov. 26, 2015

(54) METHOD AND SYSTEM TO EVALUATE ASSESS AND ENHANCE INDIVIDUAL/GROUP SKILL SET FOR TEAM OR INDIVIDUAL EFFICIENCY

(71) Applicant: Jadav Manirao SAMPATH, Bangalore (IN)

(72) Inventor: Jadav Manirao SAMPATH, Bangalore (IN)

(21) Appl. No.: 14/616,912

(22) Filed: Feb. 9, 2015

(30) Foreign Application Priority Data
May 23, 2014 (IN) 2563/CHE/2014

(51) Int. Cl. G09B 7/00

(52) U.S. Cl. CPC G09B 7/00

(57) ABSTRACT

The embodiments herein disclose a method and system to evaluate assess and enhance human potential in an individual or group environment. A user answers a set of questions compiled by a behavior model. The questions are based on the personality or the personality traits which need to be assessed. Reports are generated in a plurality of forms which provide a comprehensive analysis while also suggesting remedial measures. A people intelligence tool identifies group and individual effectiveness in order to select competencies to formulate a virtual team.

The present application claims priority to co-pending India patent application serial no. 2563/CHE/2014, filed on May 23, 2014.

### TECHNICAL FIELD

Embodiments of the invention relates generally to assessing and evaluating an individual or a group with respect to values, qualities, and attributes using behavioral assessment tools and more particularly to offering processes to enhance efficiency and effectiveness at either individual or group level

### BACKGROUND

In an increasingly competitive world, it has become necessary for a person to be ever alert and equipped with not only the right mindset but also the required skill set. Realizing this need various organizations, educational institutions, government foundations and others have offered and pursued a plethora of assessment tools and development programs to assess and improve the human mind.

Some organizations prefer to assess a person or a group based on a prescribed personality test, while others put the individuals to test with an assorted range of puzzles, brain twisters, IQ tests and so on. These organizations are of the impression that the prescribed tests and assessments will help identify the weak or strong areas of a person's mindset and once they have identified it, they may prefer to train/develop a person in the area which they think the person is lacking. This works well for a muscle or an organ in the human body which needs exercise to be strengthened where a certain set of exercises and conditioning works well for almost every individual, but the human mind is a different concept altogether. Scientists regard it as a complex system possessing more than a trillion cells many of which have more than a thousand connections. Out of this enormous complexity, patterns of cognition, emotion and behavior somehow emerge. What laws, principles and mechanisms make this possible? How does the human brain really work? What is its relation to what people do? How do human brains work together? These are the burning questions that drive research in the field of assessing and evaluating training program to judge a person by his mental skills.

In the present era, most assessment tools evaluate a person based on different parameters and slot them into specific categories or sub categories. Irrespective of different personalities, thinking patterns, right or left brain functioning, these tests categorize the population into predefined slots. Not only is the human brain a complex and remarkable organ, every individual is different from one another and his/her thought pattern will vary in most aspects compared to everyone else. For example, a right brained person will value responsibility more than late coming and a left brained person will value rationality over kindness.

There are also a significant amount of human attributes and characteristics and a mere personality or an IQ test will just unravel a very tiny portion of an individual's qualities. Additionally, certain assessments can offer a detailed diagnosis but they do not go further to offer detailed learning courses to help overcome the identified limitations. Other such programs are self-raters that elicit responses only from the individual. These programs offer diagnosis and action items based on the individual's perception of self and do not factor in others' (colleagues, bosses, direct reports, friends, mentors) feedback or opinions, which may be entirely different from the individuals self-perception. Thus, these programs end up short in evaluating a person in some form or the other.

In an existing method, techniques for monitoring neurophysiologic indicators of the members of a team while performing one or more collaborative tasks, for analyzing the collected neurophysiologic data and environmental data is disclosed. According to some embodiments, expert data can be used to identify team metrics (metrics which are indicative of whether a group is performing well as a team). However, this method does not perform a thorough multi rater review and also does compare ratings given by different respondent categories. It also does not provide suggestions and triggers to learn more module conceptual information.

In another existing method, techniques for a services-oriented system for knowledge assessment and learning is disclosed. Further, the method discloses knowledge assessment and learning that accurately assesses the true extent of a learner's knowledge, and provides learning or educational materials remedially to the subject according to identified areas of deficiency. However, this method does not review individual or group effectiveness & efficiency, identify development needs. Further, there is not also disclosed a process for virtual team formation which allows putting together a team for a new assignment or project.

In yet another existing method, a method is disclosed for a computerized training system for training an individual in self-evaluation and to interact with a partner. The training system and methods comprise an intelligence assessor to identify an intelligence makeup of the individual by scoring a completed intelligence questionnaire. Further, an asset assessor assesses the relative strength of a few assets of the individual. However, this method does not provide a development module for recommended learning to facilitate learning and development.

In light of the above, there appears to be a need for a thorough and comprehensive method and system to evaluate, assess, and enhance human potential.

### BRIEF DESCRIPTION OF THE VIEWS OF DRAWINGS

In the accompanying figures, similar reference numerals may refer to identical or functionally similar elements. These reference numerals are used in the detailed description to illustrate various embodiments and to explain various aspects and advantages of the present disclosure.

FIG. 1 is a block diagram depicting the components in a evaluation and assessment system, according to embodiments as disclosed herein a flow diagram depicting the process of obtaining scores for subsystem 1, according to the embodiments as disclosed herein;

FIG. 2 is a flow diagram depicting the mode of operation in the evaluation and assessment, according to embodiments as disclosed herein;

FIG. 3 is a block diagram depicting the modules in an excellence framework, according to embodiments as disclosed herein; and

FIG. 4 illustrates a computing environment implementing the application, according to embodiments disclosed herein;

### SUMMARY

Accordingly, the invention provides a method to evaluate, assess and enhance a parameter such as a character attribute, mental skill, organizational behavior, and an emotional response of at least one individual. The method comprises of compiling a questionnaire, receiving an input corresponding to a question of the questionnaire where the questionnaire is designed based on a pre-determined model. Further, input is processed which is received from one or more users answering the questionnaire, then users are organized into sub groups with attributes such as specific goals, values, relationships and evaluation results. Finally, results or reports are provided in one or more forms to determine actions such as a remedial measure, training program, suggestions and feedback.

Accordingly, the invention provides a computer implemented system to evaluate, assess, and enhance at least one parameter among character attributes, mental skills, organizational behavior and emotional response. The system comprises a plurality of input modules configured to collect data from one or members of a team, a data analysis server which is configured to store executable programmed modules and a processor which is configured to execute programmed modules. The system further comprises a feedback module which is configured to generate feedback for at least one member of the team based on certain responses received from the individual, a report generation module which is configured to generate at least one performance report exhibited by the individual or team during the performance of the one or more collaborative tasks.

### DETAILED DESCRIPTION OF THE EMBODIMENTS

The present disclosed and claimed subject matter provides a system and method that can be utilized with a variety of different client devices, including but not limited to desktop computers and mobile devices such as PDA's, smart phones, cellular phones, tablet computers, and laptops. Thus, while the disclosed and claimed subject matter may be embodied in many different forms, the drawings and discussion are presented with the understanding that the present disclosure is an exemplification of the principles disclosed herein and is not intended to limit to any of the disclosed embodiments illustrated.

The following detailed description is intended to provide example implementations to one of ordinary skill in the art, and is not intended to limit the disclosed and claimed subject matter to the explicit disclosure, as one of ordinary skill in the art will understand that variations can be substituted that are within the scope of the subject matter as described and claimed.

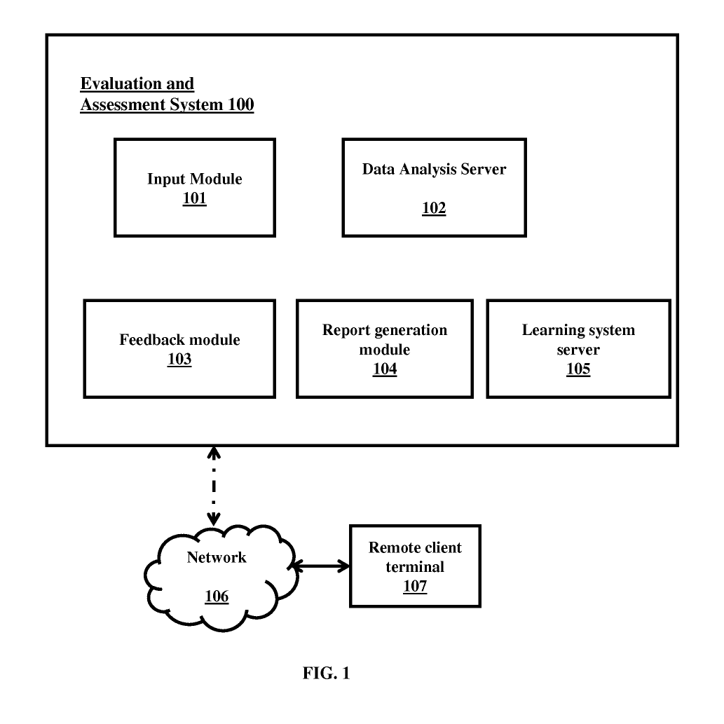

FIG. 1 is a block diagram depicting the components in an evaluation and assessment system, according to embodiments as disclosed herein. As depicted in FIG. 1 the evaluation and assessment system 100 comprises of an input module 101, data analysis server 102, feedback module 103, report generation module 104, and a learning system server 105. The evaluation and assessment system 100 is connected to a suitable network such as internet. The evaluation and assessment system 100 can also be run offline if the user has installed the system 100.

In an embodiment the evaluation and assessment system 100 can be run on any device that is connected to a suitable network 106. The device can be a handheld device such as a smart phone, tablet, Personal Digital Assistant (PDA) and the like or the device can be embedded in a portable computer (Laptop and the like).

The present invention seeks to provide the basis for development and recommended learning based on assessment scores. The assessments can be either a self-rater or a multi-rater assessment. Once this analysis is provided the intelligence tool of the present invention reviews individual or group effectiveness and efficiency to identify development needs.

The input module 101 receives data from one or more users using the evaluation and assessment system 100. This data is received when users respond to queries or while performing one or more collaborative tasks assigned by the evaluation and assessment system 100. The data received is also further monitored and analyzed for other detailed aspects. The inputs are aligned to achieve or represent outcomes through behavioral activities directed towards organizing teamwork to achieve collective goals.

The data analysis server 102 comprises a database which has a list of pre-determined questions and surveys to be answered by the user. The questions are pre-determined and are listed in a chronological order. Different stages of evaluation and assessment require a unique set of questions to be asked. The questions are based on an exhaustive list of permutations and combinations which is required for obtaining an understanding in one particular aspect. (For example, responsibility assessment). The data analysis server 102 also comprise records of users such as their registration details, member ship details, scores and stage level learning details. For example, some programs of the evaluation and assessment system 100 may be open to all and free for use, while some programs can be accessed only by a registered member and is a paid subscription. These login details of users are available with the data analysis server 102.

The feedback module 103 is configured to process and conduct a detailed analysis. The feedback module 103 maps a plurality of characteristics vis-à-vis identified attributes and allots scores or grading for a particular input. The scores may vary depending on the type of test, some tests may have a right or wrong answer, while some tests may have a detailed assessment without underscoring right or wrong. The feedback module 103 analyzes the input received by the user and recommends further tests or questionnaires for a more detailed assessment. The feedback module 103 is also configured to store and archive data retrieved from one or more users.

The report generation module 104 is configured to display reports pertaining to a user's response of one or more questionnaires. The reports can be in the form including but not limited to a progress card, report sheet, audio visual report and a suggestion or story card to facilitate further learning and development. The report generation module 104 highlights the implications of the gap and recommends one or more action items to bridge the gaps. The report generation module 104 also works similar to a Learning and Management system where it identifies improvement areas to recommend online or offline learning modules.

In an embodiment, the report generation module 104 provides a detailed analysis of the impact of the individual's vision-value alignment on certain dimensions (context sensitivity, change sensitivity, system and process sensitivity, action orientation, conflict orientation, leadership orientation and so on) along with recommended action items for each of these dimensions.

The learning system server 105 is configured to identify a learning session for each particular attribute. Since every individual has a unique intelligence and emotional makeup, the learning system server 105 identifies a particular set of questions to be asked to an individual based on the user's earlier assessments. Thus, a highly individualistic and customized report can be presented to an individual or a group of individuals.

Essentially, the present invention conveys an excellence framework which is designed to assess, analyze and enhance human potential in order to achieve excellence at individual and organizational levels.

In an embodiment, the framework comprises of three modules namely assessment, development and people intelligence.

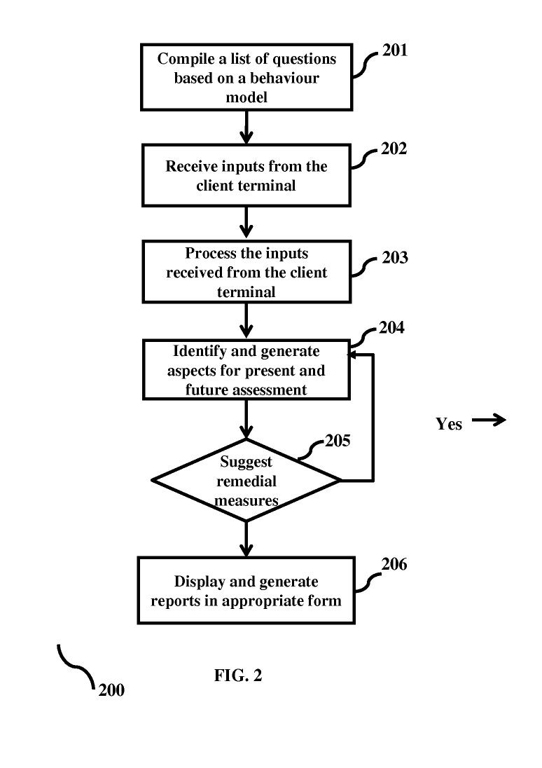

FIG. 2 is a flow diagram depicting the mode of operation in the evaluation and assessment, according to embodiments as disclosed herein. As depicted in FIG. 200, initially at step 201 a list of questions are compiled based on a behavior model. The list of questions can range from 10 to 30 or any other number deemed suitable. These questions may have a set time limit to be answered in certain embodiments.

In an embodiment, the behavior model can be an assessment module. The assessment module can be one of vision value instrument, leadership orientation, sociability orientation, value profile instrument, integrity orientation, belongingness inventory, achievement orientation, and learning orientation.

At step 202, inputs are received from one or more users from the input module 101. The inputs include answers to the compiled questions. For example, consider a sub-module in the assessment module called the Vision Value Instrument (VVI). The VVI is a self rater instrument which measures the strength of an individual's vision and values and the extent of alignment between the same. The VVI presents a set of 40 multiple choice questions and based on the input responses, a personalized report is generated instantaneously.

The VVI report includes a detailed analysis of the impact of the individual's vision value alignment on one or more parameters such as context sensitivity, change sensitivity, system and process, action orientation, conflict orientation and leadership orientation. The VVI report can also categorize leadership styles based on vision-value alignment. The categories could be extrapolated on a graph and may range from high vision, low values, and high vision, high values on one hand and low vision, low values and low vision, high values on the other hand.

The VVI instrument understands that no single value on a standalone basis is valuable, therefore values are interdependent and the User needs to understand the interdependence in order to understand an individual's behavior.

Further, at step 203 the input received are processed by the data analysis server 102. The processing can include for example a comparison of group and group related tasks. Group related data from a monitored session can be compared to expert data or data retrieved from a previous session from one or more teams. The comparison allows the session to be analyzed, reviewed and discussed by users and their peers.

Once the processing is performed, at step 204 a detailed analysis report is generated to identify and generate aspects for future and present assessment. This report can be shared between users through a social networking site or through e-mail. A report can be presented in various forms depending on the type of test opted by the user. The report offers a unique insight into the personality and the mental make-up of the user in that particular attribute being tested upon.

### EXEMPLARY EMBODIMENT

Consider a scenario, where an individual is being tested for skills such as purpose, vision, value clarification, risk taking, belongingness, integrity orientation, building conviction and other such related skills. Initially, the user logs in to the desired portal and is presented with a set of questions related to every particular attribute. Once the user has finished answering the set of questions, he is presented with a set of reports. The reports can be a comprehensive analysis of one particular attribute and suggestions to improve on the same or it may be a comparative analysis with respect to other attributes. The various actions in method 200 may be performed in the order presented, in a different order or simultaneously. Further, in some embodiments, some actions listed in FIG. 2 may be omitted.

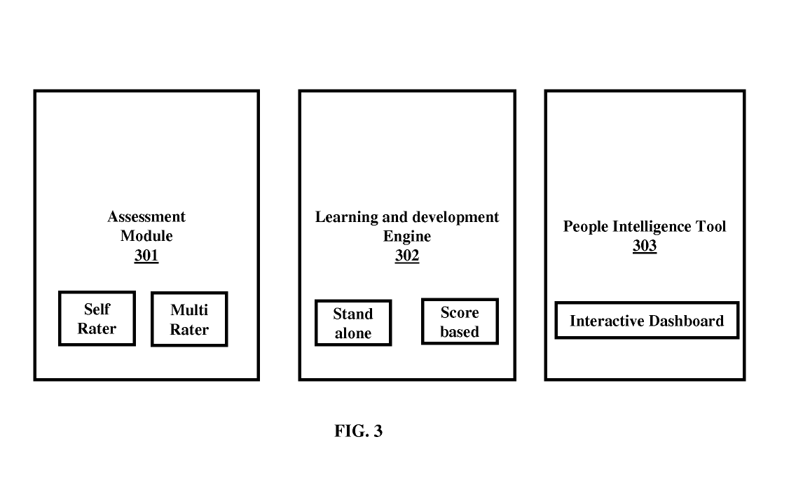

FIG. 3 is a block diagram depicting the modules in an excellence framework, according to embodiments as disclosed herein. As depicted in FIG. 3, the excellence framework in an evaluation and assessment system 100 comprises of modules such as an Assessment module 301, a learning and development engine 302, a people intelligence tool 303. The assessment module 301 comprises of sub modules such as self rater and multi rater. The learning and development engine 302 comprises of sub modules such as stand-alone and score based. The people intelligence tool 303 comprises of an interactive dashboard.

The Value Profile Instrument (VPI) is a multi rater instrument. The VPI measures the Action-Perception Gap that is the difference between how an individual perceives their actions and how others (peers) experience the individual. This enables the individual to rate themselves across a plurality of predominant qualities that influence their behavior in personal and professional life. For example, the individual can invite respondents such as Bosses, colleagues, team members, spouses, friends, relatives, teachers, and mentors and so on. A plurality of VPI attributes such as achievement, sociability, leadership, integrity, and learning are emphasized.

The assessment module 301 also comprises of a self-rater instrument called the Belongingness Inventory (BI). The BI is a self rater instrument. The BI measures the extent of belongingness experienced by a “knowledge worker” at work place. Further, the BI elicits responses across dimensions such as clarity of organizational vision, professionalism in functioning, rewards, alignment of individual and organizational values, sense of ownership, exploration and development of potential, material comforts, emotional satisfaction and value for contribution.

In an embodiment, the assessments can be either self-rater or multi-rater assessments where the user or peer can answer a set of questions about personality traits pertaining to a certain dimension.

The learning and development engine 302 is recommended learning based on assessment scores, learning modules which consist of conceptual information to facilitate learning and development. The learning and development engine 302 offers two types of learning which are score-based and stand-alone based.

The learning and development engine 302 comprise of conceptual information, audio visuals, situation-reaction tests, integration sheets, interactive quizzes and story cards to facilitate learning and development. In score based learning, the VPI identifies the action-perception gap across a plurality of attributes. The resulting report generated by the report generation module 104 highlights the implications of the gap and recommends action items to bridge the gaps. In standalone learning the user may choose from over a plurality of learning modules without taking up assessments. The stand alone courses can be pursued without having to take up any assessments. The user views the list of available courses and purchases one or more modules.

The People Intelligence (PI) tool 303 reviews individual or group effectiveness for efficiency and to identify development needs. The data retrieved from VPI assessment forms the basis for people analytics. The PI module 303 provides people analytics for individuals, teams, groups or an entire organization.

The PI module 303 helps the individual view and compare ratings given by different respondent categories and also helps identify those attributes where the individual has a greater action-perception gap. The PI module 303 also provides daily, timely or hourly tips and things to do to help bridge gaps between present score and desired score.

The PI module 303 comprises interactive dashboards based on assessment scores across user types such as individuals and team leaders/managers for improvement areas, self-development, competency analysis, style flexing, motivators and focus areas. If a user subscribes for standalone courses, they are displayed on the dashboard where the user can complete the courses online.

During score based learning, the user is recommended courses based on their assessment scores. Initially, the user selects a multi-rater instrument for purchase to start the self assessment. Then the payment process is completed and the assessment is available on the PI dashboard. Once the process is completed, reviewed and self assessment is submitted the user invites respondents and gets them to complete the questionnaire. A personalized report is generated and is made available on the dashboard.

The PI module 303 identifies improvement areas based on the respondent's scores. The dashboard displays links to the learning and development engine 302. The user follows the link to see the list of recommended learning courses so that the user can complete the recommended courses.

In an embodiment, while using a self rater assessment the Organization user assigns assessments to group members, the members obtain account details via e-mail or any other suitable notification. The members may log on and complete the self assessment and once the self assessment is done, the members get to view their report. The organization user can track progress and send reminders.

In an embodiment, while using multi rater assessment the Organization user assigns assessments to group members, the members obtain account details via e-mail or a suitable notification (such as an SMS). An organization user is any user who has access to the Evaluation and Assessment system 100. The members log on and complete self-assessment and then invite respondents. The members complete self assessment and allow the respondents to complete the questionnaire and then the members get to view the report generated by the report generation module 104. A user in an organization can track progress and send reminders at regular or customized intervals.

For individuals using score based learning courses, reports are generated and available on the dashboard for each member. For each member the PI tool identifies improvement areas based on their respondent's scores and the interactive dashboard displays a list of recommended learning courses.

The usage of the PI Dashboard in organizations is comprised of a series of steps. Initially at Step 1, the process of assigning assessments takes place. The Organization user assigns assessments to group members and then the members complete self assessment. The members invite respondents and after completing the questionnaire, the reports generated are available on the dashboard for each member. The respondent scores of all the members who have answered the questionnaire are now available in the database which provides the basis for PI.

Step 2, comprises of defining groups and owners where the organization user selects the competencies that the groups are to be analyzed with. The owners can analyze data of their corresponding groups. However, an option is provided where the owners cannot view the member scores.

Step 3 comprises of analyzing group data where a group owner can select any individual from the group and view the top 5 motivators for that individual and the style flexing to be adopted with that individual. Owner can view competency scores for the group which are categorized under High, Moderate, and Low. The competency scores are based on respondent category where these competencies are identified with low scores. Effective management and reviews help in identifying key parameters to focus on when working with the group.

In a preferred embodiment, the PI module 303 helps in the formulation of a virtual team that is for the purpose of putting a team together for a new assignment/project. Virtual team formation that helps identifies selection of competencies which the new team has to possess so that a competency benchmark is set. People from a group are selected to see if they match the benchmark set. Finally people are moved in and out of the virtual team till the combination meets the benchmark.

Consider an example, where an organization wants to select 30 members for their important project. The team manager requires a set of similar people but with different skills or talent scope. At least 5 employees need to rate high for sincerity and diligence while other 10 employees need to have the ability to identify, analyze, and pursue changes that help achieve the vision and live the chosen values. The remaining need to have a mixture of leadership orientation and a proven approach towards handling conflicts. In this kind of scenario, the PI module 303 assesses the skills of employees on a plurality of parameters where the characteristics are considered as an evaluating factor. The PI module 303 offers to the user a virtual team for a particular project or requirement.

Thus overall, it can be seen that the embodiments provide an end to end solution for individual and group assessment and also promote analysis and development in almost every sphere of human potential.

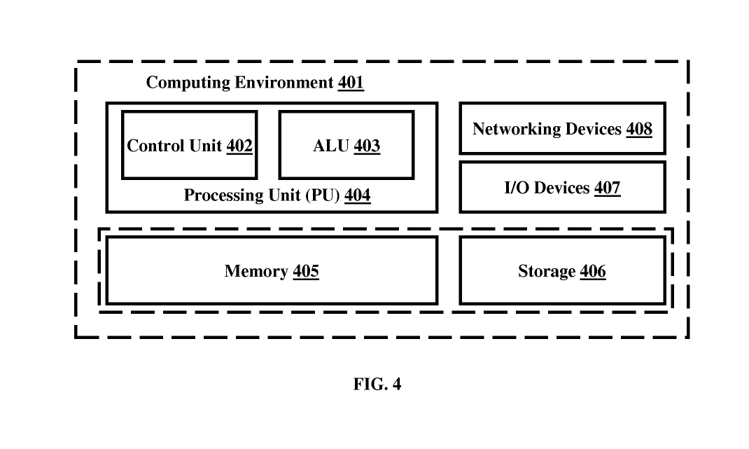

FIG. 4 illustrates a computing environment implementing the application, according to embodiments disclosed herein. As depicted the computing environment comprises at least one processing unit that is equipped with a control unit 402 and an Arithmetic Logic Unit (ALU) 403, a memory 405, a storage unit 406, plurality of networking devices 408, and a plurality Input output (I/O) devices 407. The processing unit 404 is responsible for processing the instructions of the algorithm. The processing unit 404 receives commands from the control unit 402 in order to perform its processing. Further, any logical and arithmetic operations involved in the execution of the instructions are computed with the help of the ALU 403.

The overall computing environment can be composed of multiple homogeneous and/or heterogeneous cores, multiple CPUs of different kinds, special media and other accelerators. The processing unit 404 is responsible for processing the instructions of the algorithm. The processing unit 404 receives commands from the control unit 402 in order to perform its processing. Further, any logical and arithmetic operations involved in the execution of the instructions are computed with the help of the ALU 403. Further, the plurality of process units may be located on a single chip or over multiple chips.

The algorithm comprising of instructions and codes required for the implementation are stored in either the memory unit or the storage or both. At the time of execution, the instructions may be fetched from the corresponding memory and/or storage, and executed by the processing unit.

In case of any hardware implementations various networking devices or external I/O 407 devices may be connected to the computing environment to support the implementation through the networking unit and the I/O device unit.

The embodiments disclosed herein can be implemented through at least one software program running on at least one hardware device and performing network management functions to control the elements. The elements shown in FIG. 1 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method for evaluating, assessing, and enhancing at least one of a character attribute, mental skills, organizational behavior, and emotional response of at least one individual, said method comprising:
compiling a questionnaire to determine responses from said individual;
receiving an input corresponding to at least one question of said questionnaire, the questionnaire being designed based on a pre-determined model, the pre-determined model comprising one or more test dimensions, each of the one or more test dimensions comprising one or more key areas, each of the one or more key areas having one or more behaviors, each of the one or more behaviors having one or more practices, each of the one or more practices being assigned a pre-defined level, wherein each question of the questionnaire is associated with a corresponding practice;
processing said input received from one or more users answering said questionnaire to determine at least one result in said one or more key areas;
organizing said users into subgroups with at least one of specific goals, values, relationships and evaluation results;
storing and archiving data retrieved from said users; and
providing results in one or more forms to determine at least one of a remedial measure, training programs, suggestions and feedback.

2. The method as claimed in claim 1, wherein said questionnaire comprises at least one of decision models, survey questions, votes, memes, topics, goals, roles, persona, milestones, and comments.

3. The method as claimed in claim 1, wherein said method further comprises at least one of self-rater and multi-rater assessments, wherein at least one of said user or a peer of said user answers said questionnaire about at least one personality trait.

4. The method as claimed in claim 1, wherein said method includes reviewing at least one of individual or group effectiveness with recommended action items for each of one or more dimensions.

5. The method as claimed in claim 1, wherein said method compares at least one rating given by one or more respondent categories for identifying one or more attributes, wherein said user has a action-perception gap.

6. The method as claimed in claim 1, further comprising formation of a virtual team by including selection of one or more competencies for a new team and checking whether a selected virtual team matches a pre-determined benchmark set.

7. A computer implemented system for evaluating, assessing, and enhancing at least one of a character attribute, mental skills, organizational behavior, and emotional response of at least one individual, said system comprising:
a plurality of input modules configured to collect data from one or members of a team, while the team member is performing one or more collaborative tasks;
a data analysis server comprising a non-transitory computer readable medium configured to store executable programmed modules and a processor configured to execute programmed modules stored therein;
a feedback module stored in the non-transitory computer readable medium and configured to generate feedback for at least one member of the team based on responses received from the individual while performing the one or more collaborative tasks, wherein said feedback is further configured to store and archive data retrieved from said member; and
a report generation module stored in the non-transitory computer readable medium and configured to generate at least one performance report exhibited by the team during the performance of the one or more collaborative tasks.

8. The system of claim 7, wherein said system further comprises a learning system server for storing a database of learning materials, wherein the plurality of multiple-choice questions and two-dimensional answers are stored in the database for selected delivery to a client terminal.

9. The system of claim 7, wherein said system is further configured to update a competency profile for said user by including newly determined measures of user competency from one or more newly added activity records.

10. The system of claim 7, wherein said system is further configured to receive an indication from at least one employee of a group of one or more employees, identifying completed training activities of those one or more employees, and providing a generated report that includes one or more identified completed training activities.
